(19) United States
(12) Patent Application Publication
(10) Pub. No.: US 2025/0010897 A1
(43) Pub. Date: Jan. 9, 2025

(54) TRAIN INFORMATION MANAGEMENT ASSISTANCE APPARATUS, CENTRAL DEVICE, DISPLAY DEVICE, TRAIN INFORMATION MANAGEMENT SYSTEM, TRAIN INFORMATION MANAGEMENT ASSISTANCE METHOD, AND STORAGE MEDIUM

(71) Applicant: Mitsubishi Electric Corporation, Chiyoda-ku, Tokyo (JP)

(72) Inventors: Eisho ANDO, Tokyo (JP); Shogo TATSUMI, Tokyo (JP); Akira SUGIMOTO, Tokyo (JP); Yoshihito TAKIGAWA, Tokyo (JP)

(73) Assignee: Mitsubishi Electric Corporation, Chiyoda-ku, Tokyo (JP)

(21) Appl. No.: 18/705,624

(22) PCT Filed: Dec. 9, 2021
(86) PCT No.: PCT/JP2021/045377

§ 371 Date: Apr. 29, 2024

(51) Int. Cl. B61L 25/04; B61D 37/00

(52) U.S. Cl. CPC B61L 25/04; B61D 37/00

(57) ABSTRACT

A train information management assistance apparatus includes an acquisition unit and a generation unit. The acquisition unit acquires internal signal definition information and on-board device installation information. The internal signal definition information is information in which an internal signal that is a signal for use inside a train information management apparatus to be installed in a train are defined in association with an on-board device installed in the train. The on-board device installation information is information in which the number of the on-board device installed in each car of the train is defined. The generation unit generates, based on the internal signal definition information and the on-board device installation information, packet definition information for identifying a position of the internal signal associated with the on-board device inside a packet transmitted and received inside the train information management apparatus.

### FIELD

The present disclosure relates to a train information management assistance apparatus that assists in designing signals for use in a train information management apparatus, to a central device, to a display device, to a train information management system, to a train information management assistance method, and to a train information management assistance program.

### BACKGROUND

Conventionally, a train information management apparatus is installed in a train and manages states and the like of on-board devices installed in the train. The train information management apparatus internally includes devices such as a central device and a network that connects the devices such as the central device with each other. The devices such as the central device perform various communication via the network. Here, signals for use inside the train information management apparatus by the devices such as the central device are defined by a designer or the like of the train information management apparatus. The designer needs to designate storage positions etc. on packets for storing signals indicating various information. However, as the number of on-board devices to be managed increases, man-hours increase and error is likely to occur. In response to such problems, Patent Literature 1 discloses a technique for assisting in designing plant signals for use in a monitoring control system that performs monitoring control for plant equipment.

### CITATION LIST

### Patent Literature

Patent Literature 1: Japanese Patent Application Laid-open No. 2011-180669

### SUMMARY OF INVENTION

### Problem to be Solved by the Invention

According to the above-described conventional technique, identification information is assigned to each device, and information indicating a name, a state, and the like is input for each piece of identification information. However, the train to be managed by the train information management apparatus includes a plurality of cars, and the number of cars constituting a train composition and the combination of cars are appropriately changed in accordance with the operations of the train. Thus, if the above-described conventional technique is applied to the design of signals for use in the train information management apparatus, a list of pieces of identification information of on-board devices installed in the train needs to be changed in accordance with the train composition, and there is a problem in that man-hours increase and error is likely to occur.

The present disclosure has been made in view of the above, and an object of the present disclosure is to provide a train information management assistance apparatus that can assist in designing signals for use in a train information management apparatus while reducing man-hours of a designer and occurrence of error.

### Means to Solve the Problem

To solve the above problems and achieve an object, a train information management assistance apparatus according to the present disclosure includes: an acquisition unit to acquire internal signal definition information and on-board device installation information, the internal signal definition information being information in which an internal signal that is a signal for use inside a train information management apparatus to be installed in a train is defined in association with an on-board device installed in the train, the on-board device installation information being information in which a number of the on-board device installed in each car of the train is defined; and a generation unit to generate, based on the internal signal definition information and the on-board device installation information, packet definition information for identifying a position of the internal signal associated with the on-board device within a packet transmitted and received inside the train information management apparatus.

### Effects of the Invention

The train information management assistance apparatus of the present disclosure has an effect of capable of assisting in designing the signals for use in the train information management apparatus while reducing the man-hours of the designer and the occurrence of the error.

### BRIEF DESCRIPTION OF DRAWINGS

FIG. 1 is a diagram illustrating a configuration example of a train information management system according to a first embodiment.

FIG. 2 is a diagram illustrating an example of internal signal definition information that is input to a train information management assistance apparatus according to the first embodiment.

FIG. 3 is a diagram illustrating an example of on-board device installation information that is input to the train information management assistance apparatus according to the first embodiment.

FIG. 4 is a diagram illustrating an example of packet definition information that is output from the train information management assistance apparatus according to the first embodiment.

FIG. 5 is a block diagram illustrating a configuration example of the train information management assistance apparatus according to the first embodiment.

FIG. 6 is a flowchart illustrating an operation of the train information management assistance apparatus according to the first embodiment.

FIG. 7 is a block diagram illustrating a configuration example of a central device according to the first embodiment.

FIG. 8 is a flowchart illustrating an operation in which the central device of a train information management apparatus according to the first embodiment transmits a packet.

FIG. 9 is a block diagram illustrating a configuration example of a display device according to the first embodiment.

FIG. 10 is a diagram illustrating an example of display on the display device according to the first embodiment.

FIG. 11 is a flowchart illustrating an operation in which the display device of the train information management apparatus according to the first embodiment receives the packet and performs display processing.

FIG. 12 is a diagram illustrating an example of a configuration of processing circuitry when the processing circuitry that implements a generation unit of the train information management assistance apparatus according to the first embodiment is implemented by a processor and a memory.

FIG. 13 is a diagram illustrating an example of a configuration of processing circuitry when the processing circuitry that implements the generation unit of the train information management assistance apparatus according to the first embodiment is constituted by dedicated hardware.

FIG. 14 is a flowchart illustrating an operation of a train information management assistance apparatus according to a second embodiment.

FIG. 15 is a diagram illustrating an example of packet definition information that is output from the train information management assistance apparatus according to the second embodiment.

### DESCRIPTION OF EMBODIMENTS

Hereinafter, with reference to the drawings, a description will be given in detail of a train information management assistance apparatus, a central device, a display device, a train information management system, a train information management assistance method, and a train information management assistance program according to embodiments of the present disclosure.

### First Embodiment

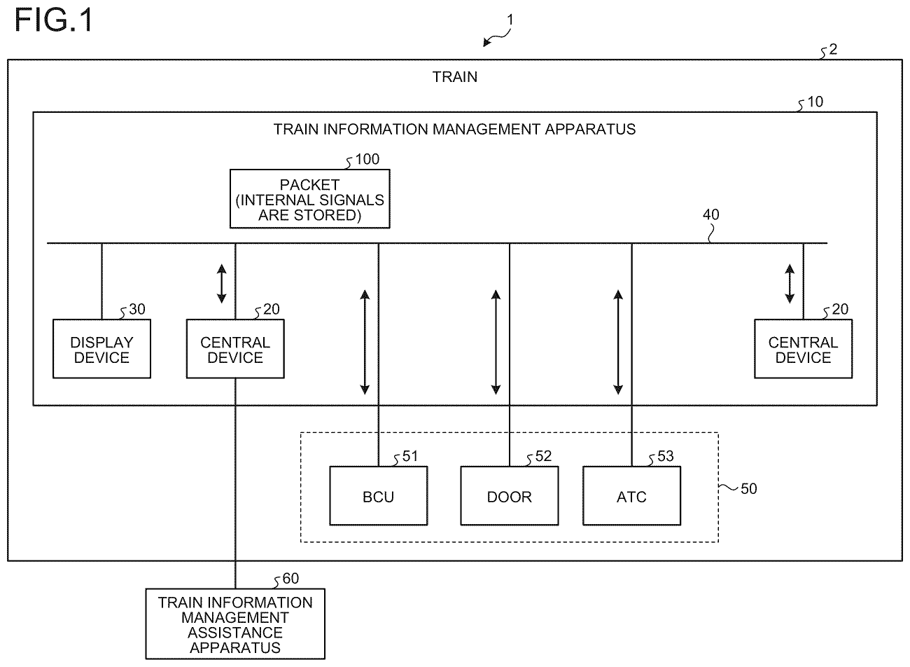

FIG. 1 is a diagram illustrating a configuration example of a train information management system 1 according to a first embodiment. The train information management system 1 includes a train information management apparatus 10 and a train information management assistance apparatus 60. The train information management apparatus 10 manages states etc. of on-board devices 50 installed in a train 2. Examples of the on-board devices 50 include, but are not limited to, a Brake Control Unit (BCU) 51, a DOOR 52, an Automatic Train Control (ATC) 53, and the like. The BCU 51 controls an operation of a brake (not illustrated). For example, opening and closing of the DOOR 52 are controlled by a door control device (not illustrated). Although simplified in FIG. 1, in the present embodiment, the following description assumes that the train 2 includes a plurality of cars and has installed therein a plurality of BCUs 51, a plurality of DOORs 52, a plurality of ATCs 53, or the like. Note that, the present embodiment is also applicable to the train 2 configured as a single-car train, and is also applicable to a configuration in which the number of some of the on-board devices 50 installed is one.

The train information management apparatus 10 includes central devices 20, a display device 30, and a network 40.

Each of the central devices 20 executes calculation processing in the train information management apparatus 10. Specifically, the central device 20 acquires, via the network 40, state information indicating operation states and the like from the on-board devices 50 installed in the train 2, and manages the states of the on-board devices 50. The central device 20 generates command information for each of the on-board devices 50 based on the state information and the like of the on-board devices 50, and transmits the command information to each of the on-board devices 50 via the network 40. Additionally, the central device 20 stores, in a packet 100, internal signals that have been obtained by calculation based on the pieces of state information and the like of the on-board devices 50, and transmits, via the network 40, the internal signals to other devices inside the train information management apparatus 10. The internal signal is a signal for use inside the train information management apparatus 10 and whose storage position inside the packet 100 is specified. Thus, the central device 20 shares the internal signals, which have been obtained by the calculation, inside the train information management apparatus 10. For example, the central device 20 transmits, via the network 40, the pieces of state information of the on-board devices 50 to the display device 30. The central device 20 may transmit, via the network 40, the pieces of state information of the on-board devices 50 to another central device 20. Note that the train information management apparatus 10 includes two central devices 20 in the example of FIG. 1, the central devices 20 may perform the same operation, or one of the central devices 20 may perform main processing in the train information management apparatus 10 and the other of the central devices 20 may operate for backup.

As will be described later, the display device 30 includes a display unit for displaying the states of the on-board devices 50 to a train driver and the like, and displays the state information of the on-board devices 50 and the like acquired from the central devices 20 via the network 40.

The network 40 is an in-train network in which the devices are connected to each other inside the train information management apparatus 10. Additionally, the on-board devices 50 are connected to the network 40. The network 40 is, for example, Ethernet (registered trademark), but is not limited thereto.

The on-board devices 50 such as the BCU 51, the DOOR 52, and the ATC 53 are connected to the network 40. The on-board devices 50 transmit, via the network 40, the state information indicating their operation states and the like to the central devices 20. Additionally, the on-board devices 50 each perform processing based on the command information acquired from the central devices 20 via the network 40, thus implementing control for the train 2 by the train information management apparatus 10. Hereinafter, when the BCU 51, the DOOR 52, and the ATC 53 are not distinguished from one another, they will be described as the on-board devices 50.

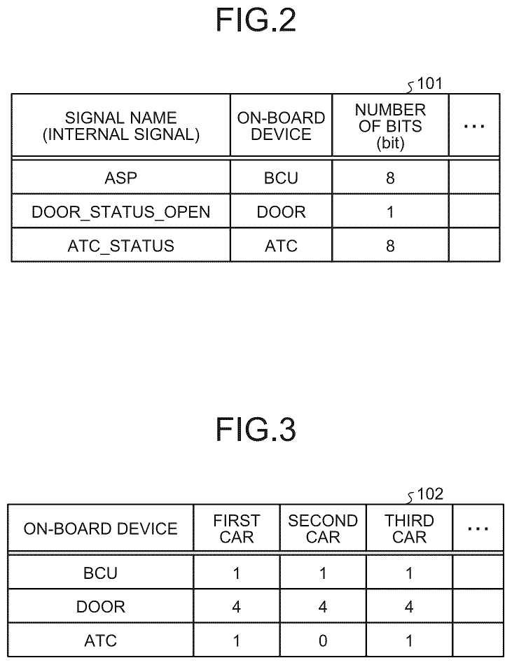

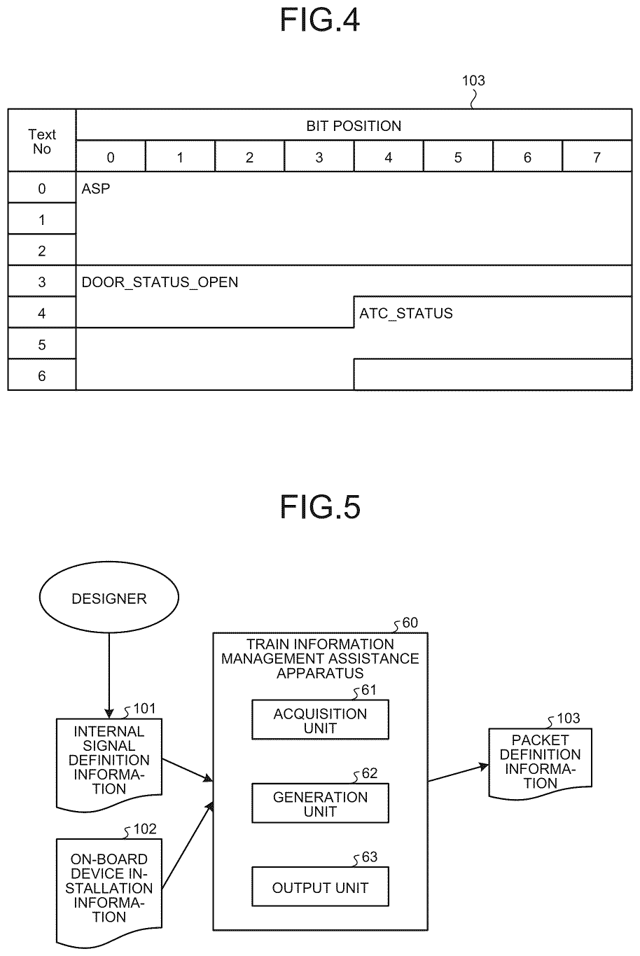

The train information management assistance apparatus 60 is an apparatus used for designing the system of the train information management apparatus 10. The train information management assistance apparatus 60 generates packet definition information 103 in which the storage positions for the internal signals in the packet 100 are defined, for the packet 100 that stores the internal signals used by the train information management apparatus 10 to be installed in the train 2. Specifically, the train information management assistance apparatus 60 receives an input of internal signal definition information 101 and on-board device installation information 102 that are defined by a designer of the train information management apparatus 10, and outputs the packet definition information 103. Here, a description will be given of the internal signal definition information 101, the on-board device installation information 102, and the packet definition information 103. FIG. 2 is a diagram illustrating an example of the internal signal definition information 101 that is input to the train information management assistance apparatus 60 according to the first embodiment. FIG. 3 is a diagram illustrating an example of the on-board device installation information 102 that is input to the train information management assistance apparatus 60 according to the first embodiment. FIG. 4 is a diagram illustrating an example of the packet definition information 103 that is output from the train information management assistance apparatus 60 according to the first embodiment.

The internal signal definition information 101 is information in which the internal signals, which are the signals for use inside the train information management apparatus 10 to be installed in the train 2, are defined in association with the on-board devices 50 installed in the train 2, by the designer of the train information management apparatus 10. The internal signal definition information 101 is information in which, for each of signal names of the internal signals, the on-board device 50 associated with a corresponding one of the internal signals and the number of bits in the packet 100 used for the corresponding internal signal are defined. The example of FIG. 2 indicates that an internal signal having a signal name ASP is associated with the BCU 51, and the number of bits of one internal signal is 8 bits. The number of bits is the number of bits used for one internal signal in the packet 100, and represents the length of the internal signal. The example of FIG. 2 also indicates that an internal signal having a signal name DOOR_STATUS_OPEN is associated with the DOOR 52, and the number of bits of one internal signal is 1 bit. The example of FIG. 2 also indicates that an internal signal having a signal name ATC_STATUS is associated with the ATC 53, and the number of bits of one internal signal is 8 bits. The association of the internal signals with the on-board devices 50 indicates that the internal signals that are the internal signals of the train information management apparatus 10 and associated with the on-board devices 50 present as many as the number of the on-board devices 50 installed in the train 2.

For example, the internal signal having the signal name DOOR_STATUS_OPEN is associated with the DOOR 52, and as indicated by the on-board device installation information 102, four DOORs 52 are installed in each car of the train 2. Additionally, in the train 2, the on-board devices 50 are distinguished from one another based on on-board device names of the on-board devices 50, a car number of a car in which the on-board devices 50 are installed, and an in-car number in the car. Thus, there are 12 types of internal signals each having the signal name DOOR_STATUS_OPEN, such as a first DOOR 52 of a first car of the train 2, a second DOOR 52 of the first car of the train 2, a third DOOR 52 of the first car of the train 2, a fourth DOOR 52 of the first car of the train 2, . . . , and a fourth DOOR 52 of the third car of the train 2. Each of the internal signals can be identified by identifying the signal name and which one of plurality of the on-board devices 50 corresponds to the internal signal, as shown in the example of the signal name DOOR_STATUS_OPEN and the third DOOR 52 of the first car.

The on-board device installation information 102 is information in which the number of on-board devices 50 installed in each car of the train 2 is defined. In the on-board device installation information 102, which and how many of the on-board devices 50 are installed in each car of the train 2 are defined. The example of FIG. 3 indicates that, in the train 2, one BCU 51 is installed in the first car, one BCU 51 is installed in the second car, and one BCU 51 is installed in the third car. The example of FIG. 3 also indicates that, in the train 2, four DOORs 52 are installed in the first car, four DOORs 52 are installed in the second car, and four DOORs 52 are installed in the third car. The example of FIG. 3 also indicates that, in the train 2, one ATC 53 is installed in the first car, one ATC 53 is installed in the third car, and no ATC 53 is installed in the second car.

The packet definition information 103 is information for identifying the positions of the internal signals associated with the on-board devices 50, inside the packet 100 transmitted and received inside the train information management apparatus 10. The packet definition information 103 indicates to which text number and which bit position the internal signal associated with each on-board device 50 is allocated, in the packet 100. For example, the packet definition information 103 indicates that the internal signals having the signal name ASP that are associated with the BCU 51 are allocated to an area ranging from a bit position 0 of a text number 0 of the packet 100 to a bit position 7 of a text number 2 of the packet 100. Additionally, inside the area for the internal signals, the individual internal signals are arranged in a sequential order from the internal signal corresponding to the on-board device 50 of the first car of the train 2. In this case, the packet definition information 103 indicates that the internal signal having the signal name ASP with respect to the BCU 51 of the first car is allocated to an area ranging from the bit position 0 to the bit position 7 of the text number 0 of the packet 100, the internal signal having the signal name ASP with respect to the BCU 51 of the second car is allocated to an area ranging from the bit position 0 to the bit position 7 of the text number 1 of the packet 100, and the internal signal having the signal name ASP with respect to the BCU 51 of the third car is allocated to an area ranging from the bit position 0 to the bit position 7 of the text number 2 of the packet 100. As described above, when the information for distinguishing the internal signals from each other is given, the storage positions of the internal signals in the packet 100 are uniquely identified.

A description will be given of the configuration and operation of the train information management assistance apparatus 60. FIG. 5 is a block diagram illustrating a configuration example of the train information management assistance apparatus 60 according to the first embodiment. The train information management assistance apparatus 60 includes an acquisition unit 61, a generation unit 62, and an output unit 63.

The acquisition unit 61 acquires the internal signal definition information 101 and the on-board device installation information 102.

The generation unit 62 generates the packet definition information 103, based on the internal signal definition information 101 and the on-board device installation information 102. Specifically, the generation unit 62 selects one internal signal from the internal signal definition information 101, and acquires, from the on-board device installation information 102, how many on-board devices 50 associated with a selected signal that is the selected internal signal are installed in the train 2. The generation unit 62 identifies an area used for the selected signal in the packet 100, based on the number of bits of the selected signal and the number of installed on-board devices 50. The generation unit 62 repeatedly performs processing of identifying the area for the number of internal signals defined in the internal signal definition information 101, thus generating the packet definition information 103.

The output unit 63 outputs the packet definition information 103 generated by the generation unit 62 to the central devices 20, the display device 30, and the like that are included in the train information management apparatus 10. A method according to which the output unit 63 outputs the packet definition information 103 to the central devices 20 and the display device 30 is not particularly limited. The packet definition information 103 may be output via communication such as wireless communication or wired communication, or may be output via a storage medium or the like. Note that, although in the example of FIG. 1 the train information management assistance apparatus 60 is connected to the central device 20 of the train information management apparatus 10, it is sufficient that the train information management assistance apparatus 60 is connected to the central device 20 when the packet definition information 103 is output. During the operation of the train 2, the train information management assistance apparatus 60 is not necessarily connected to the central device 20 of the train information management apparatus 10.

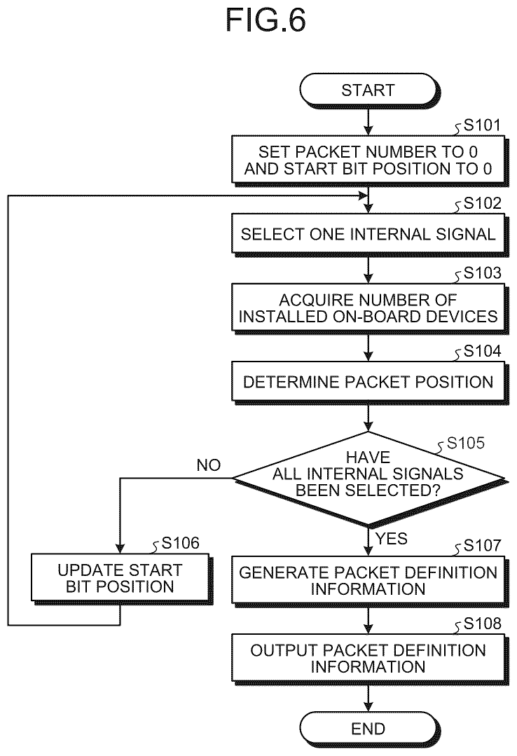

FIG. 6 is a flowchart illustrating an operation of the train information management assistance apparatus 60 according to the first embodiment.

In the train information management assistance apparatus 60, the generation unit 62 initializes a start position to allocate the internal signals in the packet 100. Specifically, the generation unit 62 sets a packet number to 0 and a start bit position to 0 (step S101).

The acquisition unit 61 acquires internal signal definition information 101 from the designer or the like of the train information management apparatus 10, and outputs the internal signal definition information 101 to the generation unit 62. The generation unit 62 selects one internal signal from the internal signal definition information 101 (step S102). Thus, the generation unit 62 acquires information indicating the signal name of the selected internal signal, the on-board device 50 associated with the selected internal signal, and the number of bits of the internal signal. For example, in the example of FIG. 2, the generation unit 62 acquires information indicating the internal signal having the signal name ASP, the BCU 51 as the on-board device 50 associated with the internal signal, and the number of bits of the internal signal being 8 bits.

The acquisition unit 61 acquires on-board device installation information 102 from the designer or the like of the train information management apparatus 10, and outputs the on-board device installation information 102 to the generation unit 62. The generation unit 62 acquires, from the on-board device installation information 102, how many on-board devices 50 associated with the selected internal signal are installed in the train 2, that is, the number of installed on-board devices 50 (step S103). For example, in the example of FIG. 3, the generation unit 62 acquires the information indicating that the number of BCUs 51, which are associated with the internal signal having the signal name ASP, installed in the train 2 is three.

The generation unit 62 multiplies the number of bits of the selected internal signal by the number of installed on-board devices 50 to calculate a bit size of an area in the packet 100 used for the selected internal signal. With the start bit position as a starting point, the generation unit 62 determines an area corresponding to the calculated bit size as a packet position in the packet 100 used for the selected internal signal (step S104). For example, in the examples of FIGS. 2 to 4, the packet position in the packet 100 used for the selected internal signal can be expressed, with respect to the internal signal having the signal name ASP, as the area ranging from the bit position 0 of the text number 0 of the packet 100 of the packet number 0 to the bit position 7 of the text number 2 of the packet 100 of the packet number 0. Note that, in the packet 100, each bit position can also be expressed by a serial number of the bit position starting from the bit position 0 of the text number 0. For example, the bit position 7 of the text number 2 can be expressed as a bit position 23 as the serial number of the bit position starting from the bit position 0 of the text number 0. Such an expression method is an effective expression method in performing various calculations in the generation unit 62 and the like.

If an end bit position of the area in which the bit size calculated with the start bit position as the starting point is provided exceeds the bit position specified by the packet size of the packet 100 of the current packet number, the generation unit 62 increments the packet number that is used for identifying the packet 100, from the bit position that exceeds the packet size. The packet size of the packet 100 is, for example, 1400 bytes, but is not limited thereto. Note that, 1 byte is equal to 8 bits. That is, in the example of FIG. 4, 1 byte is equivalent to an area corresponding to one text number.

When there is an internal signal that has not been selected from the internal signal definition information 101 (step S105: No), the generation unit 62 updates the start bit position (step S106). Specifically, the generation unit 62 sets a bit position next to the above-described end bit position as a start bit position of the internal signal to be selected next. For example, in FIG. 4, since the end bit position of the internal signal having the signal name ASP is the bit position 7 of the text number 2 of the packet number 0, the generation unit 62 updates the start bit position to the bit position 0 of the text number 3 of the packet number 0, for the internal signal having the signal name DOOR_STATUS_OPEN to be selected next. Note that, when the updated start bit position exceeds the bit position specified by the packet size of the packet 100 of the current packet number, the generation unit 62 performs increments the packet number that is used for identifying the packet 100.

As described above, the generation unit 62 sets a bit position of a bit disposed next to a last bit of an area of a first selected signal in the packet 100, as a bit position of a first bit of an area of a second selected signal to be selected next to the first selected signal in the packet 100.

The generation unit 62 repeats the above operation until all the internal signals have been selected from the internal signal definition information 101. Specifically, in the example of FIG. 2, the generation unit 62 selects the internal signal in the order of the internal signal having the signal name DOOR_STATUS_OPEN and next the internal signal having the signal name ATC_STATUS. When all the internal signals have been selected from the internal signal definition information 101 (step S105: Yes), the generation unit 62 generates packet definition information 103, based on the packet positions determined for all the selected internal signals (step S107). The generation unit 62 outputs, via the output unit 63, the packet definition information 103 to the central devices 20 and the display device 30 that are included in the train information management apparatus 10 (step S108). Note that, the generation unit 62 may output, together with the packet definition information 103, the internal signal definition information 101 and the on-board device installation information 102 to the central devices 20 and the display device 30.

Thus, as illustrated in FIG. 4, the train information management assistance apparatus 60 can provide, in the packet 100, an area for three BCUs 51 corresponding to the number of BCUs 51 installed in the train 2, for the internal signals having the signal name ASP. The train information management assistance apparatus 60 can also provide, on the packet 100, an area for 12 DOORs 52 corresponding to the number of DOORs 52 installed in the train 2, for the internal signals having the signal name DOOR_STATUS_OPEN. The train information management assistance apparatus 60 can also provide, on the packet 100, an area for two ATCs 53 corresponding to the number of ATCs 53 installed in the train 2, for the internal signals having the signal name ATC_STATUS.

Here, as a comparative example, a method of designating internal signals using packet numbers will be described. Specifically, the internal signals having the signal name ASP will be described as an example. The internal signals having the signal name ASP present as many as the number of installed BCUs 51 as in the present embodiment. In the method of designating the internal signals using the packet numbers, it is necessary to distinguish the internal signals from each other by assigning a number after the signal name to indicate each of the internal signals having the signal name ASP, and designate the packet number of the packet in which each of the internal signals is stored. An example is as follows: “signal name=ASP1, packet number=packet 1”, “signal name=ASP2, packet number=packet 1”, “signal name=ASP3, packet number=packet 1”, and the like. Note that, the packet number may be a packet name. In such a case, when the bit positions in the packet in which the internal signals are stored are changed in accordance with, for example, a change in the composition of the train 2, or when the number of internal signals is changed in accordance with, for example, a specification change, the information for identifying the internal signals needs to be changed. The internal signals are referred to in various processing, and all of such processing needs to be changed, which needs man-hours and is likely to cause error. Additionally, even for internal signals of the same type, individual signal names need to be designated in order to identify positions of the internal signals in the packet, which makes it difficult to simplify the description of repetitive processing.

On the other hand, the present embodiment enables the identification of the internal signals by designating the signal names, the car numbers of the cars in which the on-board devices 50 associated with the signal names are installed, and the in-car number. Note that, it is also possible to designate serial numbers of the on-board devices 50 in the train 2 instead of the car numbers and the in-car numbers. An example is as follows: “signal name=ASP, serial number of BCU 51=0”, “signal name=ASP, serial number of BCU 51=1”, “signal name=ASP, serial number of BCU 51=2”, and the like. In the present embodiment, no error is involved because the internal signals can be designated as described above, thus making it unnecessary to designate the packet number of the packet 100 in which the internal signals are stored. Additionally, in the present embodiment, for the internal signals of the same type, the on-board devices 50 associated with the internal signals can be designated by the serial numbers of the on-board devices 50, thus making it possible to simplify the description of repetitive processing.

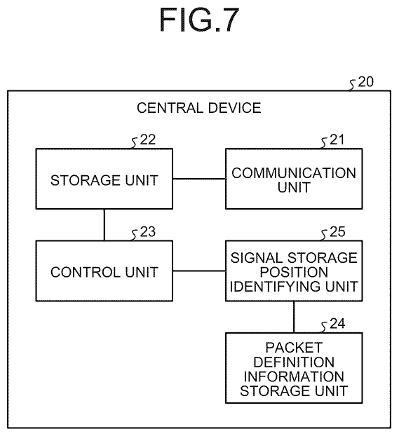

Next, a description will be given of a configuration of each of the central devices 20 that are included in the train information management apparatus 10 and use the packet definition information 103 generated by the train information management assistance apparatus 60. FIG. 7 is a block diagram illustrating a configuration example of the central device 20 according to the first embodiment. The central device 20 includes a communication unit 21, a storage unit 22, a control unit 23, a packet definition information storage unit 24, and a signal storage position identifying unit 25.

The communication unit 21 receives, from each of the on-board devices 50 installed in the train 2, state information indicating an operation state of the on-board device 50 together with identification information that can identify the installation position of the on-board device 50 in the train 2. The communication unit 21 transmits command information generated by the control unit 23 to each of the on-board devices 50. Additionally, the communication unit 21 transmits and receives the packet 100 to transmit and receive internal signals to and from another central device 20. The communication unit 21 transmits the packet 100 to output the internal signals to the display device 30.

The storage unit 22 stores the packet 100 transmitted and received by the communication unit 21, the state information and the identification information received by the communication unit 21, the command information to be transmitted from the communication unit 21, and the like.

The control unit 23 calculates the pieces of command information, the internal signals, and the like that are signals output to the on-board devices 50, based on the pieces of state information, the internal signals, and the like of the on-board devices 50 connected to the train information management apparatus 10. The internal signal may be a specific numerical value or may be selected from specified values. Additionally, the control unit 23 notifies the signal storage position identifying unit 25 of the information indicating the type of each of the on-board devices 50, and of the identification information of each of the on-board devices 50 transmitted together with the state information from the on-board device 50. Note that, when the identification information of the on-board device 50 includes the information indicating the type of the on-board device 50, it is sufficient that the control unit 23 notifies the signal storage position identifying unit 25 of only the identification information of the on-board device 50. The control unit 23 stores the internal signals in the positions identified by the signal storage position identifying unit 25 to generate the packet 100, and controls to transmit the packet 100 from the communication unit 21 to the devices included in the train information management apparatus 10 via the storage unit 22.

The packet definition information storage unit 24 stores the packet definition information 103 generated by the train information management assistance apparatus 60.

The signal storage position identifying unit 25 identifies, based on the packet definition information 103 and the pieces of identification information of the on-board devices 50, positions where the pieces of state information is stored in the packet 100 as the internal signals that are signals for use inside the train information management apparatus 10. Specifically, the signal storage position identifying unit 25 identifies the storage positions of the internal signals in the packet 100, based on the names of the on-board devices 50, the signal names of the internal signals, the serial numbers of the on-board devices 50 in the train 2, and the like. The signal storage position identifying unit 25 acquires the storage position of the designated internal signal in the packet 100 in accordance with the calculation formula of Formula (1) below.

$$Storage position of internal signal = start bit position + number of bits \times ( serial number of on - board device 50 - 1 ) . \qquad ( 1 )$$

When the serial number of the on-board device 50 is 1, the storage position of the internal signal is the start bit position. The signal storage position identifying unit 25 acquires the start bit position based on the start position of the internal signal in the packet definition information 103, and acquires the number of bits from the internal signal definition information 101. The signal storage position identifying unit 25 acquires the serial numbers of the on-board devices 50 in accordance with the number of on-board devices 50 that is counted from the lead car of the train 2 based on the on-board device installation information 102. The central device 20 may acquire the on-board device installation information 102 from the train information management assistance apparatus 60 or from the designer or the like of the train information management apparatus 10. For example, when the car number of the train 2 is G and the in-car number is N, the signal storage position identifying unit 25 can calculate the serial number of the on-board device 50 in accordance with Formula (2).

$$Serial number of on - board device 50 = total number of installed on - board devices 50 from first car to G - 1 car + N . \qquad ( 2 )$$

When G is 1, the serial number of the on-board device 50 is N. Note that, when the central device 20 receives the packet 100 from another central device 20, the signal storage position identifying unit 25 can identify, based on the packet definition information 103, the signal names of the internal signals, the serial numbers of the on-board devices 50 in the train 2 for the on-board devices 50 corresponding to the internal signals, and the like, from the positions of the internal signals stored in the packet 100.

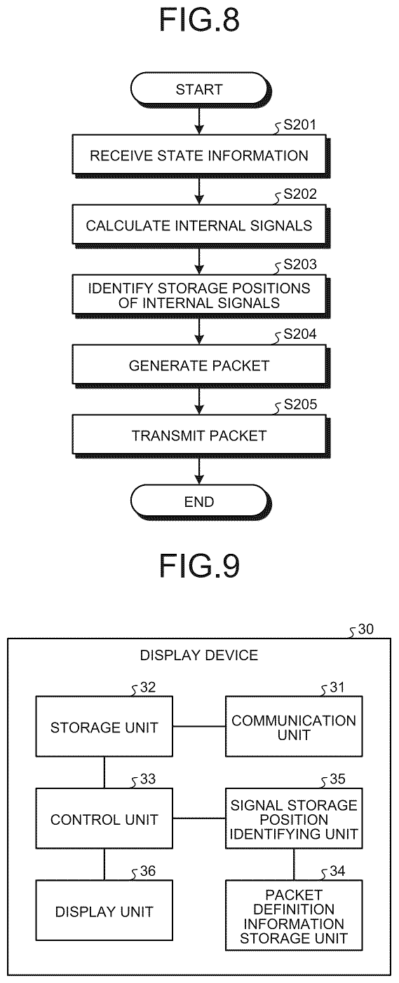

A description will be given of an operation in which the central device 20 receives the state information from each of the on-board devices 50 and transmits the packet 100 using the packet definition information 103. FIG. 8 is a flowchart illustrating an operation in which the central device 20 of the train information management apparatus 10 according to the first embodiment transmits the packet 100. In the central device 20, the communication unit 21 receives the state information from each of the on-board devices 50 (step S201). The communication unit 21 stores the pieces of state information of the on-board devices 50 in the storage unit 22. The control unit 23 reads the pieces of state information of the on-board devices 50 from the storage unit 22, and calculates internal signals in accordance with specified processing (step S202). The control unit 23 acquires, from the pieces of state information of the on-board devices 50, on-board device names of the on-board devices 50, serial numbers of the on-board devices 50 in the train 2, and the like, and notifies the signal storage position identifying unit 25 of the acquired information. Upon acquiring the information such as the on-board device names of the on-board devices 50 and the serial numbers of the on-board devices 50 in the train 2 from the control unit 23, the signal storage position identifying unit 25 identifies the storage positions of the internal signals that correspond to the on-board devices 50, in the packet 100, based on the packet definition information 103 stored in the packet definition information storage unit 24 (step S203). The signal storage position identifying unit 25 notifies the control unit 23 of the identified storage positions of the internal signals. The control unit 23 generates the packet 100 in which the internal signals whose values are obtained by the calculation are stored in the storage positions acquired from the signal storage position identifying unit 25 (step S204). The control unit 23 stores the generated packet 100 in the storage unit 22. The communication unit 21 reads the packet 100 from the storage unit 22 and transmits the packet 100 to another central device 20, the display device 30, and the like inside the train information management apparatus 10 (step S205).

Next, a description will be given of a configuration of the display device 30 that is included in the train information management apparatus 10, uses the packet definition information 103 generated by the train information management assistance apparatus 60, and receives the packet 100 from the central device 20. FIG. 9 is a block diagram illustrating a configuration example of the display device 30 according to the first embodiment. The display device 30 includes a communication unit 31, a storage unit 32, a control unit 33, a packet definition information storage unit 34, a signal storage position identifying unit 35, and a display unit 36.

The communication unit 31 receives the packet 100 from the central device 20.

The storage unit 32 stores the packet 100 received by the communication unit 31.

The control unit 33 notifies the signal storage position identifying unit 35 of the position information on the internal signals stored in the packet 100. The control unit 33 controls the display unit 36 to display the state information of each of the on-board devices 50, based on an arrangement of the on-board devices 50 in the train 2 corresponding to the internal signals identified by the signal storage position identifying unit 35.

The packet definition information storage unit 34 stores the packet definition information 103 generated by the train information management assistance apparatus 60.

The signal storage position identifying unit 35 identifies, based on the packet definition information 103 and the position information on the internal signals stored in the packet 100, an arrangement of the on-board devices 50 installed in the train 2 and corresponding to the internal signals. Specifically, the signal storage position identifying unit 35 identifies the signal names of the internal signals, the on-board devices 50 corresponding to the internal signals, the serial numbers of the on-board devices 50 in the train 2 for the on-board devices 50, and the like. At this time, the signal storage position identifying unit 35 uses the on-board device installation information 102, and the display device 30 may acquire the on-board device installation information 102 from the train information management assistance apparatus 60 or from the designer or the like of the train information management apparatus 10.

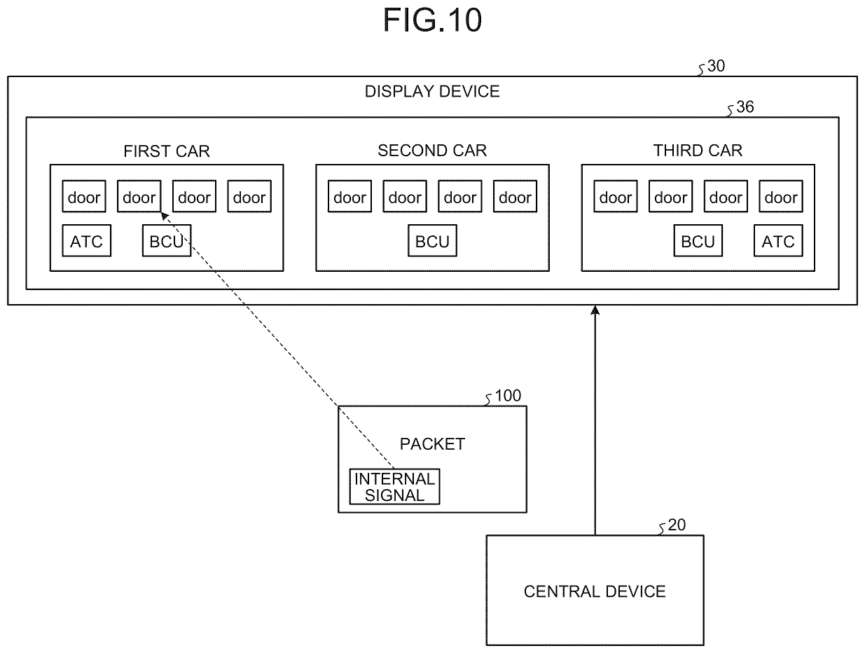

The display unit 36 is installed in a cab or the like of the train 2, and displays state information and the like of the on-board device 50 to a train driver or the like of the train 2. The display unit 36 performs, under the control of the control unit 33, display or the like based on the internal signals stored in the packet 100. FIG. 10 is a diagram illustrating an example of display on the display device 30 according to the first embodiment. Upon acquiring the information related to the bit positions of the internal signals stored in the packet 100 from the control unit 33, the signal storage position identifying unit 35 identifies, for the internal signals, the signal names of the internal signals, the serial numbers of the on-board devices 50 in the train 2 for the on-board devices 50 corresponding to the internal signals, and the like, based on the packet definition information 103. On the basis of the information acquired from the signal storage position identifying unit 35, that is, the signal names of the internal signals and the serial numbers of the on-board devices 50 in the train 2 for the on-board devices 50 corresponding to the internal signals, the control unit 33 controls the display unit 36 to perform display for the on-board devices 50 in accordance with the internal signals. FIG. 10 illustrates an example in which information indicating whether the DOOR 52 of the train 2 is open is linked to a display element indicating a door on the screen of the display unit 36, and the internal signal having the signal name DOOR_STATUS_OPEN is associated with the display element. The display unit 36 includes the display elements indicating doors as many as the number of DOORs 52 defined in the on-board device installation information 102 in order to perform display on the screen as illustrated in FIG. 10. The DOORs 52 can be distinguished from each other by the car number and the in-car number in the train 2. Since the car number and in-car number of each DOOR 52 in the train 2 are associated with the car number and in-car number for designating the internal signal having the signal name DOOR_STATUS_OPEN in the packet 100, it is possible to simply associate the internal signals in the packet 100 with the display elements of the display unit 36.

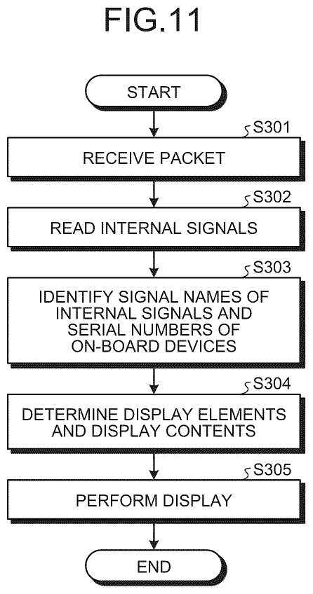

A description will be given of an operation in which the display device 30 receives the packet 100 from the central device 20 and performs display processing on the display unit 36 using the packet definition information 103. FIG. 11 is a flowchart illustrating an operation in which the display device 30 of the train information management apparatus 10 according to the first embodiment receives the packet 100 and performs display processing. In the display device 30, the communication unit 31 receives the packet 100 from the central device 20 (step S301). The communication unit 31 stores the packet 100 in the storage unit 32. The control unit 33 reads the packet 100 from the storage unit 32 and reads the internal signals from the packet 100 (step S302). The control unit 33 notifies the signal storage position identifying unit 35 of the information on the bit positions in the packet 100 in which the internal signals are stored. Upon acquiring the information of the bit positions in the packet 100 from the control unit 33, the signal storage position identifying unit 35 identifies the signal names of the internal signals corresponding to the bit positions in the packet 100 and the serial numbers of the on-board devices 50 in the train 2, based on the packet definition information 103 stored in the packet definition information storage unit 34 (step S303). The signal storage position identifying unit 35 notifies the control unit 33 of the identified signal names of the internal signals and the identified serial numbers of the on-board devices 50 in the train 2. Note that, as described above, the car number and the in-car number may be used instead of the serial numbers. The control unit 33 determines display elements that are display targets included in the display unit 36, based on the signal names of the internal signals and the serial numbers of the on-board devices 50 in the train 2, which have been acquired from the signal storage position identifying unit 35, and determines display content in accordance with the internal signals (step S304). The display unit 36 performs display processing for the display elements determined by the control unit 33, in accordance with the internal signals determined by the control unit 33 (step S305).

Next, a description will be given of a hardware configuration of the train information management assistance apparatus 60 according to the first embodiment. In the train information management assistance apparatus 60, the acquisition unit 61 is an interface that receives data. The output unit 63 is an interface that outputs data. The generation unit 62 is implemented by processing circuitry. The processing circuitry may include a memory that stores a program and a processor that executes the program stored in the memory, or may include dedicated hardware. The processing circuitry is also referred to as control circuitry.

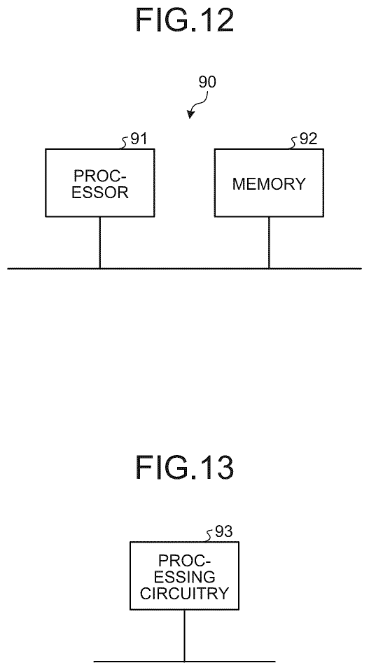

FIG. 12 is a diagram illustrating an example of a configuration of processing circuitry 90 when the processing circuitry that implements the generation unit 62 of the train information management assistance apparatus 60 according to the first embodiment is implemented by a processor 91 and a memory 92. The processing circuitry 90 illustrated in FIG. 12 is control circuitry, and includes the processor 91 and the memory 92. When the processing circuitry 90 includes the processor 91 and the memory 92, each function of the processing circuitry 90 is implemented by software, firmware, or a combination of software and firmware. The software or the firmware is described as a program and stored in the memory 92. In the processing circuitry 90, the processor 91 reads and executes the program stored in the memory 92 to implement functions. That is, the processing circuitry 90 includes the memory 92 for storing a program with which processing of the train information management assistance apparatus 60 is executed as a result. It can also be said that this program is a program for causing the train information management assistance apparatus 60 to execute functions implemented by the processing circuitry 90. This program may be provided by a storage medium storing the program or may be provided through other means such as a communication medium.

It can also be said that the program is a program for causing the train information management assistance apparatus 60 to execute: a first step of, by the acquisition unit 61, acquiring the internal signal definition information 101 and the on-board device installation information 102, the internal signal definition information 101 being information in which an internal signal that is a signal for use inside the train information management apparatus 10 to be installed in the train 2 is defined in association with the on-board device 50 installed in the train 2, the on-board device installation information 102 being information in which the number of on-board device 50 installed in each car of the train 2 is defined; and a second step of, by the generation unit 62, generating, based on the internal signal definition information 101 and the on-board device installation information 102, the packet definition information 103 for identifying the position of the internal signal associated with the on-board devices 50, inside the packet 100 transmitted and received inside the train information management apparatus 10.

Here, the processor 91 is, for example, a Central Processing Unit (CPU), a processing unit, an arithmetic unit, a microprocessor, a microcomputer, a Digital Signal Processor (DSP), or the like. Additionally, the memory 92 corresponds to, for example, a nonvolatile or volatile semiconductor memory such as a Random Access Memory (RAM), a Read Only Memory (ROM), a flash memory, an Erasable Programmable ROM (EPROM), or an Electrically EPROM (EEPROM, registered trademark), a magnetic disk, a flexible disk, an optical disk, a compact disk, a mini disk, a Digital Versatile Disc (DVD), or the like.

FIG. 13 is a diagram illustrating an example of a configuration of processing circuitry 93 when the processing circuitry that implements the generation unit 62 of the train information management assistance apparatus 60 according to the first embodiment is constituted by dedicated hardware. The processing circuitry 93 illustrated in FIG. 13 corresponds to, for example, a single circuit, a combined circuit, a programmed processor, a parallel-programmed processor, an Application Specific Integrated Circuit (ASIC), a Field Programmable Gate Array (FPGA), or a combination thereof. Some functions of the processing circuitry 93 may be implemented by dedicated hardware, and the other functions may be implemented by software or firmware. In this manner, the processing circuitry 93 can implement the above-described functions using dedicated hardware, software, firmware, or a combination thereof.

The central device 20 has a similar hardware configuration. In the central device 20, the communication unit 21 is an interface capable of transmitting and receiving the packet 100 and the like. The storage unit 22 and the packet definition information storage unit 24 are memories. The control unit 23 and the signal storage position identifying unit 25 are implemented by processing circuitry. The processing circuitry may include a memory that stores a program and a processor that executes the program stored in the memory, or may include dedicated hardware. The processing circuitry is also referred to as control circuitry.

The display device 30 also has a similar hardware configuration. In the display device 30, the communication unit 31 is an interface capable of receiving the packet 100 and the like. The storage unit 32 and the packet definition information storage unit 34 are memories. The display unit 36 is a display such as a Liquid Crystal Display (LCD). The control unit 33 and the signal storage position identifying unit 35 are implemented by processing circuitry. The processing circuitry may include a memory that stores a program and a processor that executes the program stored in the memory, or may include dedicated hardware. The processing circuitry is also referred to as control circuitry.

As described above, according to the present embodiment, the train information management assistance apparatus 60 generates the packet definition information 103 in which the storage positions of the internal signals, for use in the central device 20 and the display device 30, on the packet 100 are defined, at the time of designing the train information management apparatus 10 by using the internal signal definition information 101 and the on-board device installation information 102. As a result, the train information management assistance apparatus 60 can reduce the amount of the man-hours required for definitions such as the definition of the number of the on-board devices 50 by the designer of the train information management apparatus 10, and the definition on the packet 100, and can prevent or reduce an increase in time for designing due to the error in description of calculation processing. Additionally, the train information management assistance apparatus 60 can reduce the man-hours required to design by improving design reusability between different car systems. As described above, the train information management assistance apparatus 60 can assist in designing signals for use in the train information management apparatus 10 while reducing the man-hours of the designer of the train information management apparatus 10 and the occurrence of the error.

### Second Embodiment

In the first embodiment, in the packet definition information 103 generated by the train information management assistance apparatus 60, as illustrated in FIG. 4, the areas corresponding to the internal signals having the different signal names are sometimes included in the same text number. That is, areas corresponding to internal signals having multiple signal names are sometimes included in a unit of 1 byte. In the second embodiment, a case will be described in which the train information management assistance apparatus 60 determines the areas corresponding to the internal signals having the different signal names such that the areas corresponding to the internal signals having the different signal names are not included in the same text number, that is, in accordance with a byte boundary.

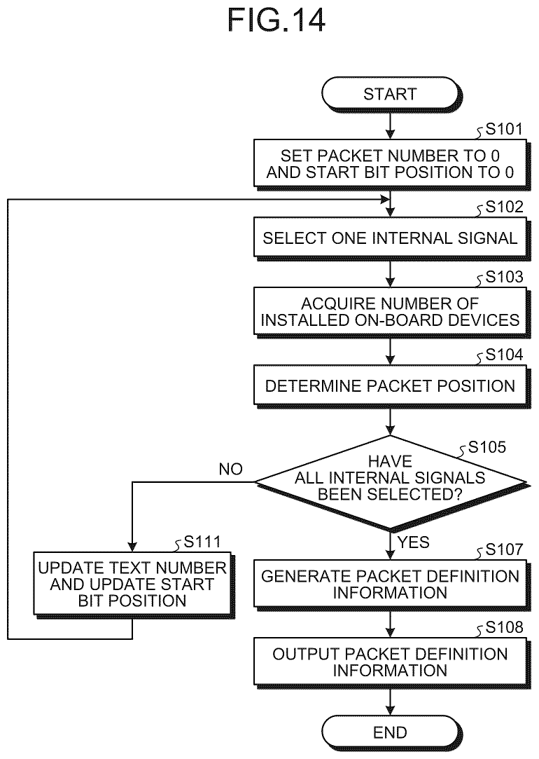

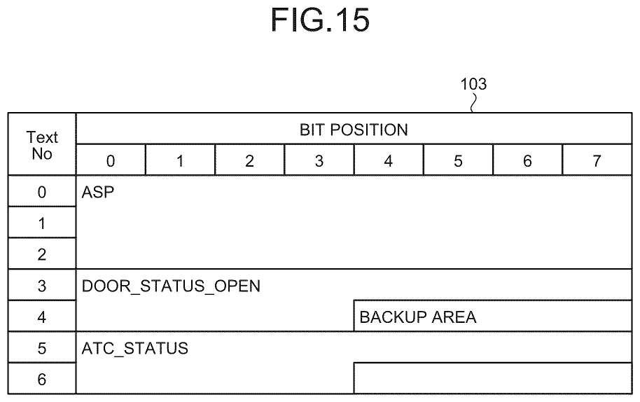

In the second embodiment, the configurations of the train information management assistance apparatus 60 and the like are similar to the configurations in the first embodiment. FIG. 14 is a flowchart illustrating an operation of the train information management assistance apparatus 60 according to the second embodiment. The flowchart illustrated in FIG. 14 differs from the flowchart in the first embodiment illustrated in FIG. 6 in an operation in step S111. When not all the internal signals have been selected from the internal signal definition information 101 (step S105: No), the generation unit 62 updates the text number and updates the start bit position (step S111). FIG. 15 is a diagram illustrating an example of the packet definition information 103 output from the train information management assistance apparatus 60 according to the second embodiment. As illustrated in FIG. 15, in the train information management assistance apparatus 60, when updating the start bit position of the internal signal in the packet 100, the generation unit 62 updates the start bit position such that the start bit position is aligned with the 8-bit boundary. The generation unit 62 determines the areas corresponding to the internal signals having the different signal names such that the areas corresponding to the internal signals having the different signal names are not included in the areas having the same text number, that is, in accordance with the byte boundary. Note that, similarly to the first embodiment, when the updated start bit position exceeds the bit position specified by the packet size of the packet 100 of the current packet number, the generation unit 62 performs processing of incrementing the packet number for identifying the packet 100.

As described above, when the packet 100 is delimited in units of 8 bits as 1 byte, the generation unit 62 sets the bit position of the first bit of the byte disposed next to the byte to which the last bit of the area of the first selected signal belongs in the packet 100, as the bit position of the first bit of the area of the second selected signal to be selected next to the first selected signal in the packet 100.

In the packet definition information 103 of the second embodiment illustrated in FIG. 15, unlike the packet definition information 103 of the first embodiment illustrated in FIG. 4, the start bit position of the internal signal having the signal name ATC_STATUS is changed from the bit position 4 of the text number 4 to the bit position 0 of the text number 5. In the first embodiment, the central device 20 and the display device 30 using the packet definition information 103 illustrated in FIG. 4 need to perform calculation processing by a byte access method and a bitwise operation in order to access internal signals. On the other hand, in the second embodiment, since the central device 20 and the display device 30 that use the packet definition information 103 illustrated in FIG. 15 can access the internal signals only by the byte access method, the processing amount at the time of execution can be reduced. In the second embodiment, only the start bit position of each internal signal in the packet 100 is changed, and the operations of the signal storage position identifying unit 25 of the central device 20 and the signal storage position identifying unit 35 of the display device 30 are similar to the operations thereof in the first embodiment.

Note that, in the present embodiment, the start bit position of each internal signal is aligned in a unit of 1 byte. That is, the area including the area corresponding to each internal signal and a backup area is aligned in units of multiples of 8 bits. However, the present embodiment is not limited thereto. The start bit position of each internal signal may be aligned in units of 2 bytes or 4 bytes. That is, the area including the area corresponding to each internal signal and the backup area may be aligned in units of multiples of 16 bits or in units of multiples of 32 bits.

As described above, according to the present embodiment, the train information management assistance apparatus 60 generates the packet definition information 103 such that the start bit position of each internal signal is in a unit of 1 byte, that is, the area including the area corresponding to each internal signal and the backup area is in units of multiples of 8 bits. This can reduce the processing amount required for the central device 20 and the display device 30 to access the internal signals.

### Third Embodiment

In the second embodiment, the start bit position is changed for every internal signal in accordance with the byte boundary. However, the train information management assistance apparatus 60 may perform the operation of the second embodiment when the internal signal whose number of bits indicated by the internal signal definition information 101 is an integral multiple of 8 bits, and may perform the operation of the first embodiment in other cases, for example.

That is, when the packet 100 is delimited in units of 8 bits as 1 byte, if the number of bits of the second selected signal selected after the first selected signal is an integral multiple of 8 bits, the generation unit 62 sets the bit position of the first bit of the byte disposed next to the byte to which the last bit of the area of the first selected signal belongs in the packet 100, as the bit position of the first bit of the area of the second selected signal in the packet 100. Additionally, when the packet 100 is delimited in units of 8 bits as 1 byte, if the number of bits of the second selected signal is other than an integral multiple of 8 bits, the generation unit 62 sets the bit position of the bit disposed next to the last bit of the area of the first selected signal in the packet 100, as the bit position of the first bit of the area of the second selected signal in the packet 100. Since the generation unit 62 has acquired the information of the internal signal definition information 101, the generation unit 62 can determine whether to perform the operation described in the first embodiment or the operation described in the second embodiment, based on, for example, the number of bits of an internal signal to be selected next.

As a result, the effect of reducing the processing amount required for the central device 20 and the display device 30 to access the internal signals is reduced as compared with the second embodiment. However, the backup area, which is illustrated in FIG. 15, provided in the packet 100 can be reduced and the size of the packet 100 can be reduced as compared with the second embodiment.

The configurations described in the above embodiments are illustrative only and may be combined with the other known techniques, the embodiments may be combined with each other, and part of each of the configurations may be omitted or modified without departing from the gist.

### REFERENCE SIGNS LIST

1 train information management system; 2 train; 10 train information management apparatus; 20 central device; 21, 31 communication unit; 22, 32 storage unit; 23, 33 control unit; 24, 34 packet definition information storage unit; 25, 35 signal storage position identifying unit; 30 display device; 36 display unit; 40 network; 50 on-board device; 51 BCU; 52 DOOR; 53 ATC; 60 train information management assistance apparatus; 61 acquisition unit; 62 generation unit; 63 output unit; 100 packet; 101 internal signal definition information; 102 on-board device installation information; 103 packet definition information.

1. A train information management assistance apparatus comprising:
first processing circuitry
to acquire internal signal definition information and on-board device installation information, the internal signal definition information being information in which an internal signal that is a signal for use inside a train information management apparatus to be installed in a train is defined in association with an on-board device installed in the train, the on-board device installation information being information in which a number of the on-board device installed in each car of the train is defined; and
to generate, based on the internal signal definition information and the on-board device installation information, packet definition information for identifying a text number and a bit position of the internal signal associated with the on-board device within a packet transmitted and received inside the train information management apparatus.

2. The train information management assistance apparatus according to claim 1, wherein
the internal signal definition information is information in which, for each signal name of the internal signal, the on-board device associated with the internal signal and a number of bits in the packet used for the corresponding internal signal are defined.

3. The train information management assistance apparatus according to claim 2, wherein
the first processing circuitry selects one internal signal from the internal signal definition information, and acquires, from the on-board device installation information, a number of the on-board device associated with a selected signal that is the internal signal selected is installed in the train, identifies an area used for the selected signal in the packet, based on a number of bits of the selected signal and the number of on-board device installed, and repeatedly performs processing of identifying the area corresponding to a number of the internal signal defined in the internal signal definition information, thus generating the packet definition information.

4. The train information management assistance apparatus according to claim 3, wherein
the first processing circuitry sets a bit position of a bit disposed next to a last bit of an area of a first selected signal in the packet, as a bit position of a first bit of an area of a second selected signal to be selected next to the first selected signal in the packet.

5. The train information management assistance apparatus according to claim 3, wherein
the packet is delimited in units of 8 bits as 1 byte, and
the first processing circuitry sets a bit position of a first bit of a byte disposed next to a byte to which a last bit of an area of a first selected signal belongs in the packet, as a bit position of a first bit of an area of a second selected signal to be selected next to the first selected signal in the packet.

6. The train information management assistance apparatus according to claim 3, wherein
the packet is delimited in units of 8 bits as 1 byte, and
the first processing circuitry
sets, when a number of bits of a second selected signal selected after a first selected signal is an integral multiple of 8 bits, a bit position of a first bit of a byte disposed next to a byte to which a last bit of an area of the first selected signal belongs in the packet, as a bit position of a first bit of an area of the second selected signal in the packet, and
sets, when the number of bits of the second selected signal is other than the integral multiple of 8 bits, a bit position of a bit disposed next to the last bit of the area of the first selected signal in the packet, as the bit position of the first bit of the area of the second selected signal in the packet.

7. A central device that is included in a train information management apparatus to be installed in a train and uses the packet definition information generated by the train information management assistance apparatus according to claim 1, the central device comprising:
a communication interface to receive, from an on-board device installed in the train, state information indicating an operation state of the on-board device together with identification information capable of identifying an installation position of the on-board device in the train;
a packet definition information storage wait to store the packet definition information; and
second processing circuitry
to identify, based on the packet definition information and the identification information, a position where the state information is stored in the packet as an internal signal that is a signal for use inside the train information management apparatus; and
to store the internal signal in the position identified by the signal storage position identifying unit to generate the packet, and to transmit the packet from the communication unit to a device included in the train information management apparatus.

8. A display device that is included in a train information management apparatus to be installed in a train,
receives a packet from the central device according to claim 7, and uses the packet definition information generated by the train information management assistance apparatus, the display device comprising:
a communication interface to receive the packet from the central device;
a packet definition information storage unit to store the packet definition information;
a display; and
third processing circuitry
to identify, based on the packet definition information and position information on a position of an internal signal stored in the packet, a placement in the train of the on-board device installed in the train that corresponds to the internal signal; and
to perform control to cause the display unit to display the state information of the on-board device, based on the identified placement in the train of the on-board device corresponding to the internal signal.

9. A train information management system comprising:
the train information management assistance apparatus according to claim 1;
a central device that is included in the train information management apparatus and uses the packet definition information, the central device comprising:
a communication interface to receive, from an on-board device installed in the train, state information indicating an operation state of the on-board device together with identification information capable of identifying an installation position of the on-board device in the train;
a packet definition information storage unit to store the packet definition information; and
second processing circuitry
to identify, based on the packet definition information and the identification information, a position where the state information is stored in the packet as an internal signal that is a signal for use inside the train information management apparatus, and
to store the internal signal in the position identified by the signal storage position identifying unit to generate the packet, and to transmit the packet from the communication unit to a device included in the train information management apparatus; and
a display device that is included in the train information management apparatus, receives the packet from the central device, and uses the packet definition information, the display device comprising:
a communication interface to receive the packet from the central device;
a packet definition information storage to store the packet definition information;
a display; and
third processing circuitry
to identify, based on the packet definition information and position information on a position of an internal signal stored in the packet, a placement in the train of the on-board device installed in the train that corresponds to the internal signal; and
to perform control to cause the display to display the state information of the on-board device, based on the identified placement in the train of the on-board device corresponding to the internal signal.

10. A train information management assistance method to be used in a train information management assistance apparatus, the train information management assistance method comprising:
acquiring internal signal definition information and on-board device installation information, the internal signal definition information being information in which an internal signal that is a signal for use inside a train information management apparatus to be installed in a train is defined in association with an on-board device installed in the train, the on-board device installation information being information in which a number of the on-board device installed in each car of the train is defined; and
generating, based on the internal signal definition information and the on-board device installation information, packet definition information for identifying a text number and a bit position of the internal signal associated with the on-board device, within a packet transmitted and received inside the train information management apparatus.

11. The train information management assistance method according to claim 10, wherein
the internal signal definition information is information in which, for each signal name of the internal signal, the on-board device associated with the internal signal and a number of bits in the packet used for the internal signal are defined.

12. The train information management assistance method according to claim 11, wherein
the generating includes selecting one internal signal from the internal signal definition information, and acquiring, from the on-board device installation information, a number of on-board device associated with a selected signal that is the internal signal selected installed in the train, identifying an area used for the selected signal in the packet based on a number of bits of the selected signal and a number of on-board device installed, and repeatedly performing processing of identifying the area corresponding to a number of the internal signal defined in the internal signal definition information, thus generating the packet definition information.

13. The train information management assistance method according to claim 12, wherein
the generating includes setting a bit position of a bit disposed next to a last bit of an area of a first selected signal in the packet, as a bit position of a first bit of an area of a second selected signal to be selected next to the first selected signal in the packet.

14. The train information management assistance method according to claim 12, wherein
the packet is delimited in units of 8 bits as 1 byte, and
the generating includes setting a bit position of a first bit of a byte disposed next to a byte to which a last bit of an area of a first selected signal belongs in the packet, as a bit position of a first bit of an area of a second selected signal to be selected next to the first selected signal in the packet.

15. The train information management assistance method according to claim 12, wherein
the packet is delimited in units of 8 bits as 1 byte, and
the generating includes
setting, when a number of bits of a second selected signal selected after a first selected signal is an integral multiple of 8 bits, a bit position of a first bit of a byte disposed next to a byte to which a last bit of an area of the first selected signal belongs in the packet, as a bit position of a first bit of an area of the second selected signal in the packet, and
setting, when the number of bits of the second selected signal is other than the integral multiple of 8 bits, a bit position of a bit disposed next to the last bit of the area of the first selected signal in the packet, as the bit position of the first bit of the area of the second selected signal in the packet.

16. A non-transitory computer-readable storage medium storing train information management assistance program causing a computer to execute the train information management assistance method according to claim 10.
